(19) United States
(12) Patent Application Publication
(10) Pub. No.: US 2008/0218676 A1
(43) Pub. Date: Sep. 11, 2008

(54) LIQUID CRYSTAL DISPLAY DEVICE AND MANUFACTURING METHOD OF THE SAME

(76) Inventors: Soon-joon Rho, Gyeonggi-do (KR); Baek-kyun Jeon, Gyeonggi-do (KR); Hee-keun Lee, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/932,292

(22) Filed: Oct. 31, 2007

(30) Foreign Application Priority Data
Mar. 9, 2007 (KR) 10-2007-0023503

(51) Int. Cl. G02F 1/1337; C23C 8/00

(52) U.S. Cl. 349/128; 427/585

(57) ABSTRACT

A liquid crystal display device includes: a first insulating substrate having a first alignment film formed thereon; a second substrate which faces the first substrate having a second alignment film formed thereon; and a liquid crystal layer in a vertically aligned mode disposed between the first alignment film and the second alignment film, at least one of the first alignment film and the second alignment film comprising a silicon oxide layer of which a dielectric constant is 5 to 14.

### CROSS-REFERENCE TO RELATED APPLICATIONS

This application claims priority from Korean Patent Application No. 10-2007-0023503, filed on Mar. 9, 2007 in the Korean Intellectual Property Office, the disclosure of which is incorporated herein by reference.

### BACKGROUND OF INVENTION

1. Field of Invention

Apparatus and methods consistent with the present invention relate to a liquid crystal display device and, more particularly, to a liquid crystal display device which includes an alignment film made of silicon oxide and a manufacturing method of the same.

2. Description of the Related Art

A liquid crystal display (LCD) device includes a first substrate where thin film transistors (TFTs) are formed, a second substrate which faces the first substrate and a liquid crystal layer interposed between the substrates.

The first substrate and the second substrate each includes an alignment film, and liquid crystal molecules in the liquid crystal layer are aligned in a predetermined direction by the alignment film.

Generally, the alignment film is made of polymer such as polyimide. However, exposure to light deteriorates the polymer and may contaminate the liquid crystal layer.

An alignment film made of an inorganic layer such as silicon oxide has been suggested, however, it is difficult to form the alignment film of silicon oxide that has uniform thickness.

### SUMMARY OF THE INVENTION

Accordingly, it is an aspect of the present invention to provide an LCD device which includes an alignment film of silicon oxide and with a uniform thickness.

Another aspect of the present invention is to provide a manufacturing method of an LCD device which includes an alignment film of silicon oxide and with a uniform thickness.

In accordance with an aspect of the invention, a liquid crystal display device includes a first insulating substrate having an alignment film formed thereon; a second substrate which faces the first substrate having an alignment film formed thereon; and a liquid crystal layer in a vertically aligned mode disposed between the alignment films, at least one of the alignment films including a silicon oxide layer of which a dielectric constant is 5 to 14.

According to an aspect of the invention, the silicon oxide layer has a thickness of 200 Å to 3000 Å.

According to an aspect of the invention, the silicon oxide layer has a surface roughness of 5 Å to 30 Å.

According to an aspect of the invention, the first substrate further includes a pixel electrode which is formed between the first insulating substrate and the first alignment and has a pixel electrode cutting pattern formed thereon, and the second substrate further includes a common electrode which is formed between the second insulating substrate and the second alignment and has a common electrode cutting pattern formed thereon.

According to an aspect of the invention, the silicon oxide layer is formed by a plasma enhanced chemical vapor deposition method.

The foregoing and/or other aspects of the present invention can be achieved by providing a manufacturing method of a liquid crystal display device including: providing a substrate to be deposited; introducing the substrate in a deposition space in a vacuum chamber; and forming an alignment film made of silicon oxide (SiOx) on the substrate by depositing a silicon source gas and an oxygen source gas using a chemical vapor deposition method at a temperature of 30° C. to 150° C. while forming plasma in the deposition space.

According to an aspect of the invention, the oxygen source gas includes nitrous oxide (N₂O).

According to an aspect of the invention, the silicon source gas includes monosilane (SiH₄).

According to an aspect of the invention, a flux ratio of the oxygen source gas over the silicon source gas is between 150 and 300.

According to an aspect of the invention, the oxygen source gas includes nitrous oxide (N₂O) and the silicon source gas includes monosilane (SiH₄).

According to an aspect of the invention, the alignment film is formed to have a thickness of 200 Å to 3000 Å.

According to an aspect of the invention, the alignment film is formed to have a dielectric constant of 5 to 14.

According to an aspect of the invention, the manufacturing method further includes applying an electron beam to the alignment film to have a pre-tilt angle.

According to an aspect of the invention, the substrate is in a horizontal position in the forming the alignment film.

According to an aspect of the invention, a pressure in the deposition space is 10⁻³ torr to 10 torr, power density of plasma is 145 W/cm³ to 580 W/cm³, and a depositing speed is 4 Å/sec to 16 Å/sec in the forming the alignment film.

According to an aspect of the invention, a thin film transistor is formed on an insulating substrate and a pixel electrode which is electrically connected to the thin film transistor has a cutting pattern formed thereon.

According to an aspect of the invention, a common electrode has a cutting pattern formed thereon on an insulating substrate.

The foregoing and/or other aspects of the present invention can be achieved by providing a manufacturing method of a liquid crystal display device including: forming an alignment film made of silicon oxide (SiOx) on a substrate by depositing a silicon source gas and an oxygen source gas using a chemical vapor deposition method at a temperature of 30° C. to 150° C. while forming plasma in the deposition space.

According to an aspect of the invention, the substrate is in a horizontal position in the forming the alignment film.

According to an aspect of the invention, a flux ratio of the oxygen source gas over the silicon source gas is between 150 and 300.

According to an aspect of the invention, the oxygen source gas includes nitrous oxide (N₂O) and the silicon source gas includes monosilane (SiH₄).

According to an aspect of the invention, the alignment film is formed to have a thickness of 200 Å to 3000 Å.

According to an aspect of the invention, the alignment film is formed to have a dielectric constant of 5 to 14.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is an arrangement view of an LCD device according to a first exemplary embodiment of the present invention;

FIG. 2 is a cross-sectional view taken along line II-II in FIG. 1;

FIGS. 3A through 3C illustrate a manufacturing method of the LCD device according to the first exemplary embodiment of the present invention;

FIG. 4 is a configuration view of a deposition apparatus used for manufacturing the LCD device according to the first exemplary embodiment of the present invention;

FIG. 5A shows a dielectric constant of a silicon oxide layer according to its thickness;

FIG. 5B shows a dielectric constant of the silicon oxide layer according to a depositing temperature;

FIG. 5C shows a dielectric constant of the silicon oxide layer according to content of a hydroxide (OH) group;

FIG. 6 shows a dielectric constant of the silicon oxide layer deposited under various depositing temperatures;

FIG. 7 illustrates another manufacturing method of the LCD device according to the first exemplary embodiment of the present invention; and

FIG. 8 is a cross-sectional view of an LCD device according to a second exemplary embodiment of the present invention.

### DETAILED DESCRIPTION

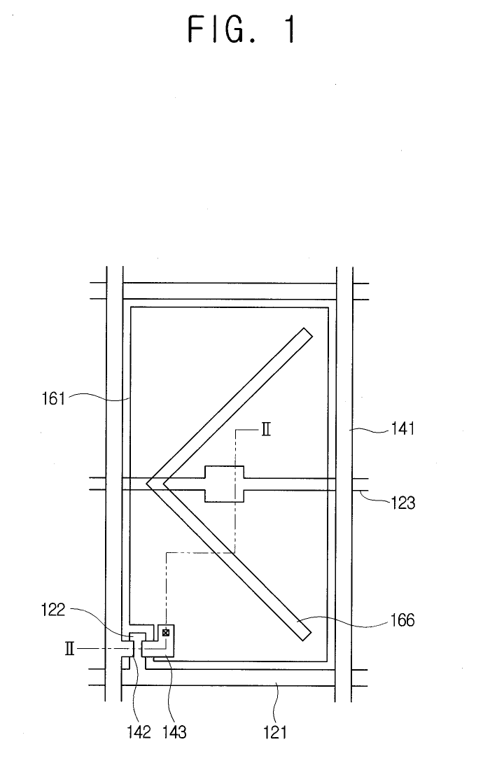

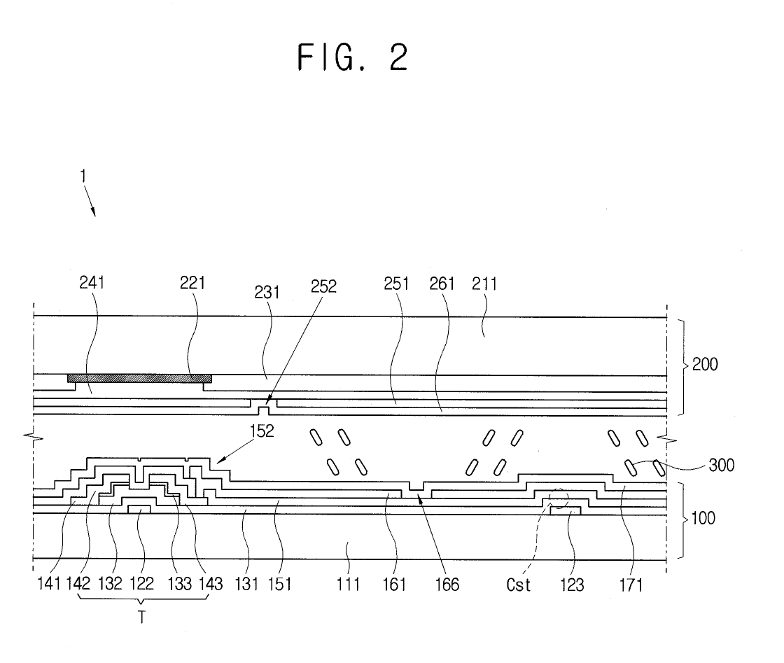

Referring to FIGS. 1 and 2, an LCD device according to a first exemplary embodiment of the present invention will be described.

An LCD device 1 includes a first substrate 100 where TFTs T are formed, a second substrate 200 which faces the first substrate 100 and a liquid crystal layer 300 disposed between the substrates 100 and 200.

First, the first substrate 100 will be described.

A gate wiring is formed on a first insulating substrate 111. The gate wiring may be provided as a single or multi metal layer. The gate wiring includes a gate line 121 which extends transversely and disposed within a display region, a gate electrode 122 connected to the gate line 121 and a storage electrode line 123 extending parallel with the gate line 121.

A gate insulating layer 131 made of silicon nitride is formed on the first insulating substrate 111 to cover the gate wiring.

A semiconductor layer 132 made of amorphous silicon or the like is formed on the gate insulating layer 131 over the gate electrode 122. An ohmic contact layer 133 made of n+ hydrogenated amorphous silicon which is highly doped with n-type impurities is formed on the semiconductor layer 132. The ohmic contact layer 133 is removed in a channel region between a source electrode 142 and a drain electrode 143.

A data wiring is formed on the ohmic contact layer 133 and the gate insulating layer 131. The data wiring may be a metal single layer or metal multi layers. The data wiring includes a data line 141 which extends vertically to intersect the gate line 121 to form a pixel, the source electrode 142 which is branched from the data line 141 and partly extends over the ohmic contact layer 133, and the drain electrode 143 separated from the source electrode 142 and partly formed over the ohmic contact layer 133 opposite to the source electrode 142.

A passivation layer 151 is formed on the data wiring and a portion of the semiconductor layer 132 which is not covered with the data wiring. A contact hole 152 is formed in the passivation layer 151 to expose the drain electrode 143.

A pixel electrode 161 is formed on the passivation layer 151. The pixel electrode 161 is made of a transparent conductive material such as indium tin oxide (ITO) or indium zinc oxide (IZO). The pixel electrode 161 is connected to the drain electrode 143 through the contact hole 152. A pixel electrode cutting pattern 166 is formed on the pixel electrode 161.

The pixel electrode cutting pattern 166 is formed to divide the liquid crystal layer 300 into a plurality of domains along with a common electrode cutting pattern 252 (described later).

A first alignment film 171 made of silicon oxide is formed on the pixel electrode 161. The first alignment film 171 has a thickness of 200 Å to 3000 Å, a dielectric constant of 5 to 14, and a surface roughness (Rrms) of 5 Å to 30 Å.

The first alignment film 171 aligns liquid crystal molecules in the liquid crystal layer 300 vertically to the substrates.

Next, the color filter substrate 200 will be described in the following.

A black matrix 221 is formed on a second insulating substrate 211. The black matrix 221 is disposed between red, green and blue filters to divide the filters, and prevents light from being irradiated directly to the TFT disposed on the first substrate 100. The black matrix 221 is typically made of a photoresist organic substance to which a black pigment is added. The black pigment may be carbon black, titanium oxide or the like.

A color filter layer 231 includes red, green and blue filters which are repeatedly disposed and separated by the black matrix 221. The color filter layer 231 endows colors to light irradiated from the backlight unit (not shown) and passing through the liquid crystal layer 300. The color filter layer 231 is usually made of a photoresist organic material.

An overcoat layer 241 is formed on the color filter 231 and the black matrix 221 which is not covered with the color filter 231. The overcoat layer 241 provides a plane surface and protects the color filter 231. The overcoat layer 241 may be formed of photoresist acryl resin.

A common electrode 251 is formed on the overcoat layer 241. The common electrode 251 is formed of a transparent conductive material such as ITO or IZO. The common electrode 251 directly applies a voltage to the liquid crystal layer 300 along with the pixel electrode 161 of the first substrate 100.

The common electrode cutting pattern 252 is formed on the common electrode 251. The common electrode cutting pattern 252 divides the liquid crystal layer 300 into a plurality of domains along with the pixel electrode cutting pattern 166 of the pixel electrode 161.

The pixel electrode cutting pattern 166 and the common electrode cutting pattern 252 may have various shapes. In other exemplary embodiments, protrusions may be provided to divide the liquid crystal layer 300 into a plurality of domains instead of the cutting patterns 166 and/or 252.

A second alignment film 261 made of silicon oxide is formed on the common electrode 251. The second alignment film 261 has a thickness of 200 Å to 3000 Å, a dielectric constant of 5 to 14, and a surface roughness of 5 Å to 30 Å.

The second alignment film 251 aligns liquid crystal molecules in the liquid crystal layer 300 vertically to the substrates.

The liquid crystal layer 300 is disposed between the first substrates 100 and the second substrate 200. The liquid crystal layer 300 is in a vertically aligned (VA) mode, where a long axis of the liquid crystal molecule is aligned perpendicular to the substrates 100 and 200 under a voltage-off state. The long axis of the liquid crystal molecule with negative dielectric anisotropy is oriented perpendicularly to an electric field in a voltage-on state.

However, if the cutting patterns 166 and 252 are not formed, the direction in which the liquid crystal molecules lie is not determined. Accordingly, the liquid crystal molecules are disorganized, and thus a disclination line is formed in an interface between the liquid crystal molecules different in the lying direction. The cutting patterns 166 and 252 generate a fringe field when a voltage is applied to the liquid crystal layer 300, thereby determining the lying direction of the liquid crystal molecules. Also, the liquid crystal layer 300 is divided into a plurality of domains depending on the arrangement of the cutting patterns 166 and 252.

In other exemplary embodiments, one of the first alignment film 171 and the second alignment film 261 may be made of polymer such as polyimide.

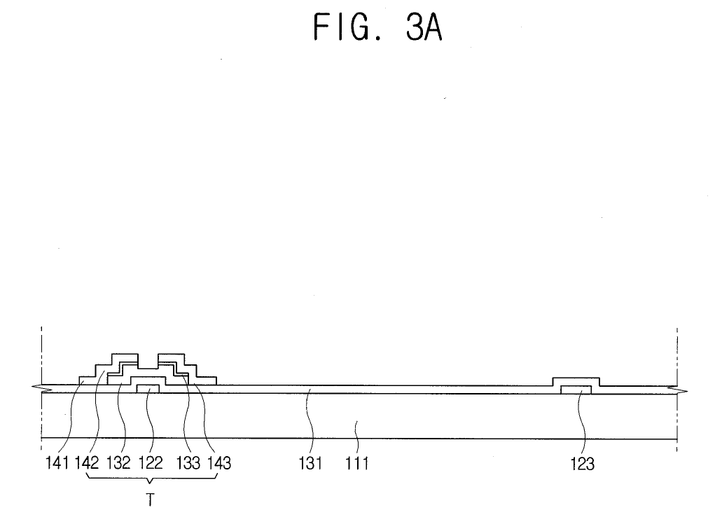

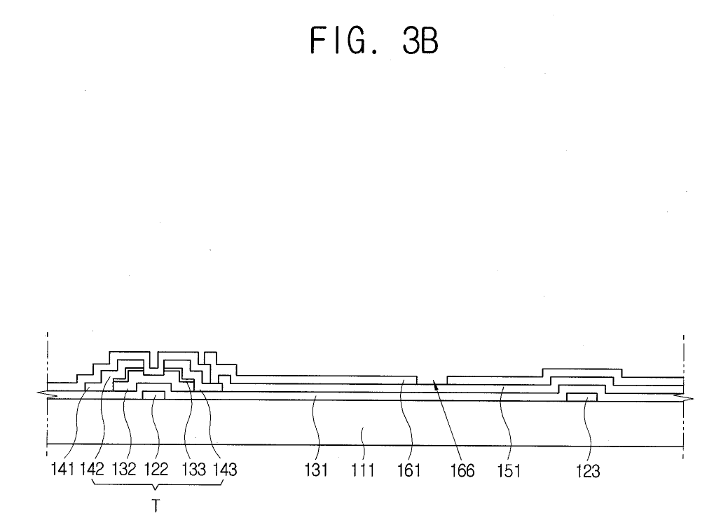

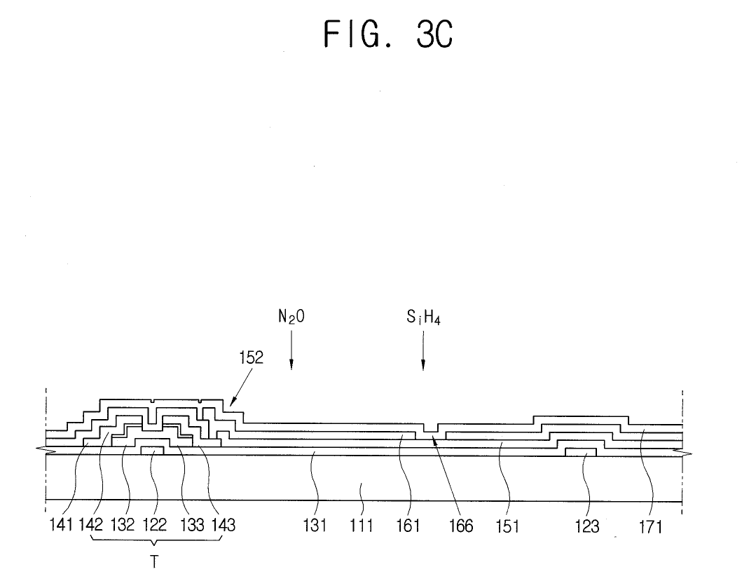

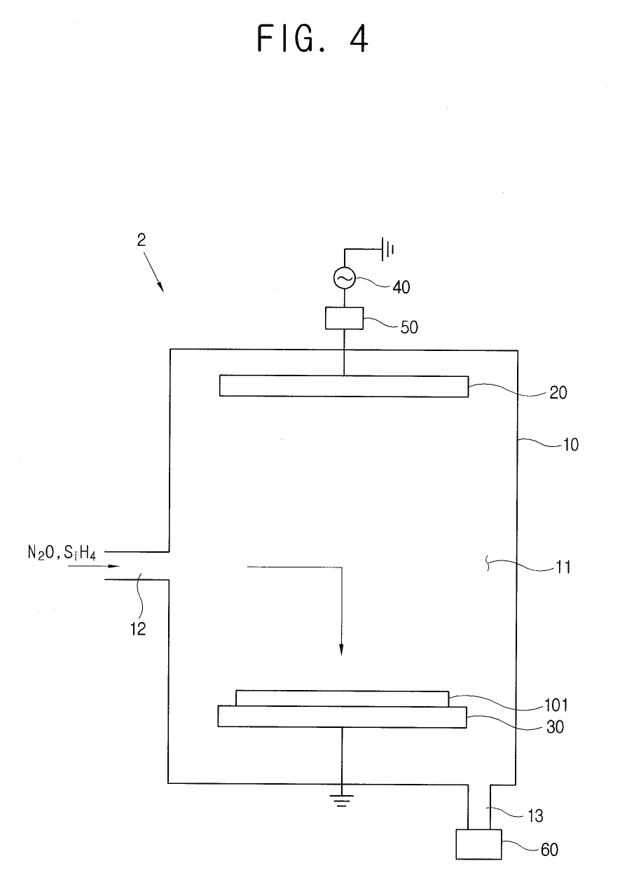

Hereinafter, a manufacturing method of the LCD device according the first exemplary embodiment of the present invention will be described with reference to FIGS. 3A to 3C and 4.

Referring to FIG. 3A, a TFT T is formed on the first insulating substrate 111.

Referring to FIG. 3B, the pixel electrode 161 which is connected to the TFT T is formed thereon, thereby providing a substrate 101 to be deposited. The pixel electrode cutting pattern 166 is formed on the pixel electrode 161.

A process until the forming of the pixel electrode 161 may be performed by a known art, which will not be explained in detail.

Referring to FIG. 3C, the first alignment film 171 is formed using a plasma enhanced chemical vapor deposition (PECVD) method, thereby completing the first substrate 100. In a deposition process, monosilane (SiH₄) may be used for a silicon source gas and nitrous oxide (N₂O) may be used for an oxygen source gas.

Referring to FIG. 4, a process of forming the first alignment film 171 will be explained in detail. FIG. 4 shows a deposition apparatus 2.

The deposition apparatus 2 includes a vacuum chamber 10 which forms a deposition space 11, a first electrode 20 disposed in an upper part of the deposition space 11, a second electrode 30 disposed in a lower part of the deposition space 11, a power supplier 40 which supplies power to the first electrode 20, an impedance matching device 50, a vacuum pump 60 which adjusts a pressure in the deposition space 11.

An inlet port 12 through which a source gas flows is formed at a lateral side of the vacuum chamber 10, and an outlet port 13 is formed at a lower side thereof to discharge a source gas which has not reacted and connected to the vacuum pump 60.

To form the first alignment film 171, the substrate 101 to be deposited is introduced on the second electrode 30. The substrate 101 is in a horizontal position.

Then, the power supplier 40 supplies power to the first electrode 20 to form plasma in the deposition space 11, and a silicon source gas, e.g., SiH₄, and a oxygen source gas, e.g., N₂O, are provided to the deposition space 11.

The silicon source gas SiH₄ and the oxygen source gas N₂O are decomposed by the plasma, thereby forming the first alignment film 171 on the substrate 101. The substrate 101 is kept to be in a horizontal position while forming the first alignment film 171.

Analysis by X-ray Photoelectron spectroscopy (XPS) confirms that the first alignment film 171 does not include nitrogen.

Processes of manufacturing the second substrate 200, adhering the first substrate 100 and the second substrate 200 and forming the liquid crystal layer may be performed by a known art, which will not explained in detail.

The second alignment film 261 of the second substrate 200 is formed by the same process as the first alignment film 171.

An experiment shows that the vertical orientation of the liquid crystal molecules is excellent if the oxide silicon layer which forms the alignment films 171 and 261 has a dielectric constant of 5 or more.

Silicon oxide generally has a dielectric constant of 3.9. However, the silicon oxide layer in the present exemplary embodiment has a dielectric constant of 5 to 14 which is relatively high, and thus the vertical orientation of the liquid crystal molecules is excellent.

A dielectric constant of the silicon oxide layer may be increased by adjusting its thickness, depositing condition, composition, etc., which will be described below.

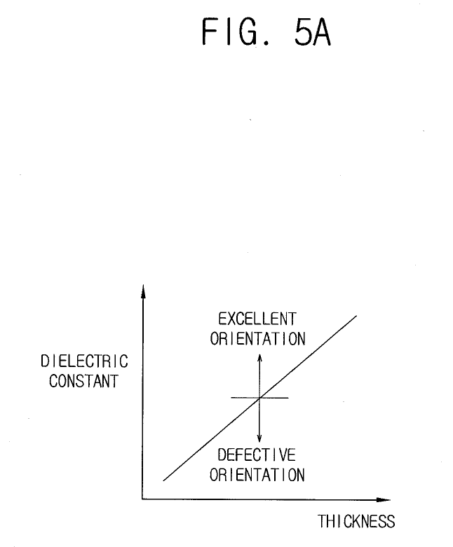

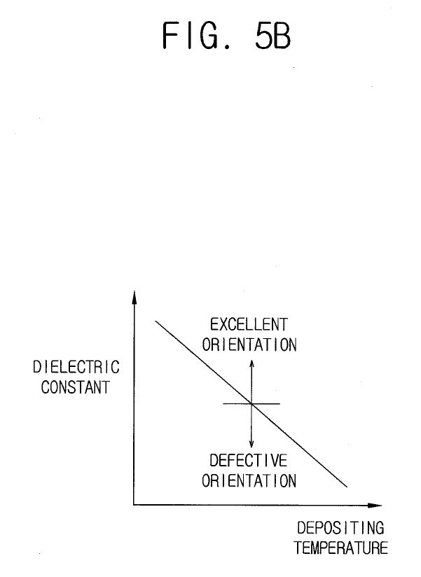

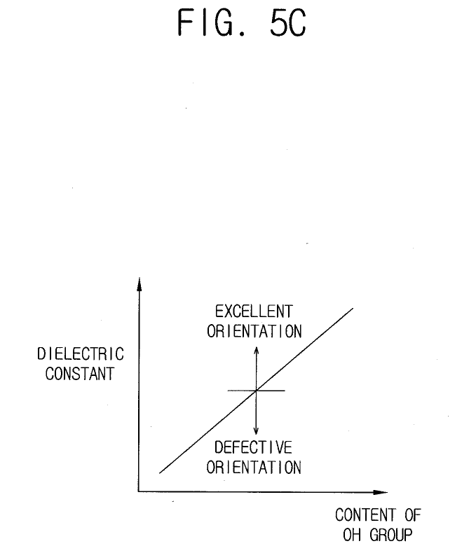

FIG. 5A shows the relation between a dielectric constant of the silicon oxide layer and its thickness. Referring to FIG. 5A, the dielectric constant of the silicon oxide layer is directly proportional to the thickness thereof.

The silicon oxide layer may be 200 Å to 3000 Å in thickness. If thickness of the silicon oxide layer is less than 200 Å, a dielectric constant thereof can not reach 5 or more. If thickness of the silicon oxide layer is more than 3000 Å, it takes excessive time to form the silicon oxide layer. Further, transmittance of light decreases, thereby reducing brightness of the LCD device 1.

If the thickness of the silicon oxide layer is between 200 Å and 800 Å, which is relatively low, a dielectric constant thereof may be increased by raising an influx ratio of the oxygen source gas/silicon source gas. A flux ratio of the oxygen source gas over the silicon source gas may be between 150 and 300. In order to increase a dielectric constant of the silicon oxide layer, a ratio thereof may be between 200 and 300.

FIG. 5B shows a relation between a dielectric constant of the silicon oxide layer and a depositing temperature. Referring to FIG. 5B, the dielectric constant of the silicon oxide layer is inversely proportional to the depositing temperature.

The depositing temperature may be between 30° C. and 150° C. If the depositing temperature is less than 30° C., it is not easy to control the temperature in the deposition space 11, and thus a silicon oxide layer with a uniform quality may not be obtained. If the depositing temperature is more than 150° C., a dielectric constant of the silicon oxide layer becomes low and can not reach 5.

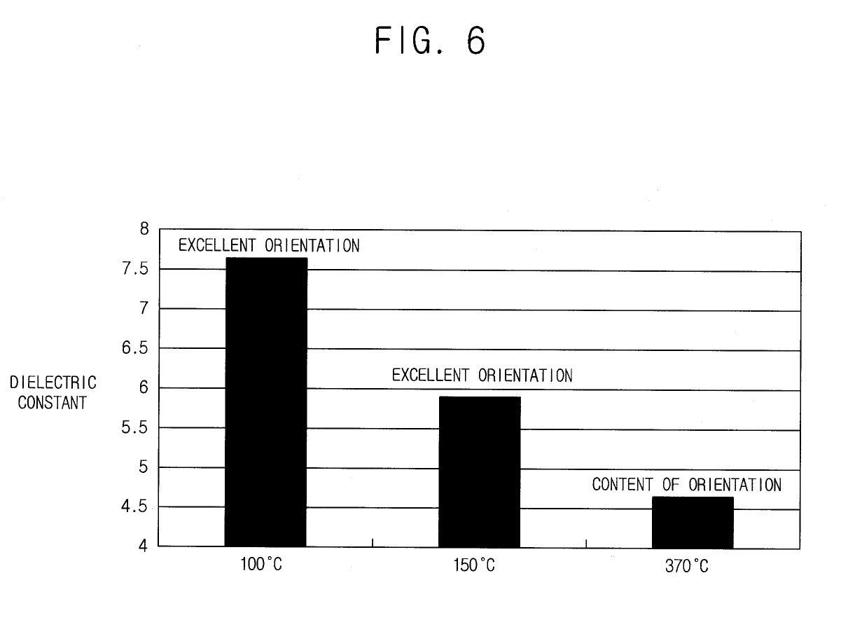

The experimentally determined relationship between the dielectric constant and the depositing temperature and the relationship between the dielectric constant and the orientation performance of the liquid crystal molecules, will be explained with reference to FIG. 6.

FIG. 6 shows the dielectric constant of a silicon oxide layer formed under various depositing temperatures. If the silicon oxide layer is formed at 100° C., the dielectric constant thereof is more than 7.5 and the orientation performance of the liquid crystal molecules is excellent. If the silicon oxide layer is formed at 150° C., the dielectric constant thereof is more than 5.5 and the orientation performance is excellent. If the silicon oxide layer is formed at 370° C., however, the dielectric constant thereof is less than 5 and the orientation performance of the liquid crystal molecules is defective.

That is, as the lower the depositing temperature, the higher the dielectric constant of the silicon oxide layer and the better the orientation performance of the liquid crystal molecules.

FIG. 5C shows a relation between the dielectric constant of the silicon oxide layer and the content of an OH group. Referring to FIG. 5C, the dielectric constant of the silicon oxide layer is directly proportional to the content of the OH group.

The content of the OH group increases under lower power density of the plasma, a lower depositing temperature, and a higher ratio of the oxygen source gas to the silicon source gas in the manufacturing process. Power density of the plasma is between 145 W/cm³ and 580 W/cm³ in the process of forming the silicon oxide.

The pressure in the deposition space 11 may be 10⁻³ torr to 10 torr, and the deposition speed may be 4 Å/sec to 16 Å/sec.

As described above, the dielectric constant of the silicon oxide layer depends on the relationship among its thickness, the depositing temperature and the content of the OH group.

For example, a high dielectric constant of the silicon oxide layer may be obtained by decreasing the depositing temperature even though the thickness of the silicon oxide layer is small. Accordingly, a silicon oxide layer with an excellent vertical orientation performance may be obtained.

Also, a high dielectric constant of the silicon oxide layer may be obtained by lowering power density of the plasma, raising the ratio of the oxygen source gas to the silicon source gas to increase the content of the OH group, and increasing the thickness of the silicon oxide layer even though the depositing temperature is somewhat high. Accordingly, a silicon oxide layer with an excellent vertical orientation performance may be obtained.

In a conventional method, a silicon oxide layer is formed on a substrate which is kept in a slant position, thereby forming a vertical alignment film. Thus, it is not easy to form a silicon oxide layer with a uniform thickness. In particular, as a substrate becomes large-sized, it is much more difficult to form a silicon oxide layer to be uniform in thickness.

In the present exemplary embodiment, the oxide silicon layer is formed on the substrate 101 which is positioned horizontally, and thus a uniform thickness is obtained. Further, the silicon oxide layer may be formed with a uniform thickness on a large-sized substrate.

The silicon oxide layer formed by the conventional method has a high surface roughness, while the silicon oxide layer according to the present exemplary embodiment has a surface roughness of 5 Å to 30 Å, which is comparatively low.

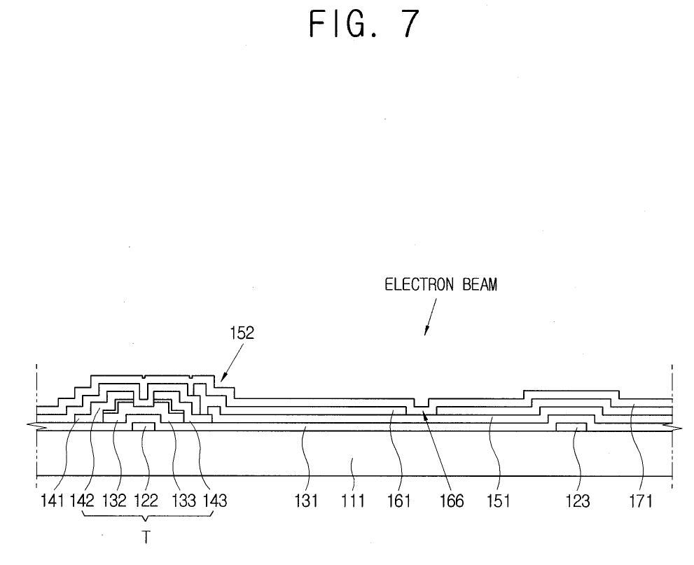

Next, another manufacturing method of the LCD device according to the first exemplary embodiment of the present invention will be described with reference to FIG. 7.

FIG. 7 illustrates a process to endow the first alignment film 171 formed by the PECVD method with a pre-tilt angle by applying an electron beam. The second alignment film 261 may be endowed with a pre-tilt angle by an electron beam as well as the first alignment film 171.

In this process, a cutting pattern may not be formed on the pixel electrode 161 and the common electrode 251.

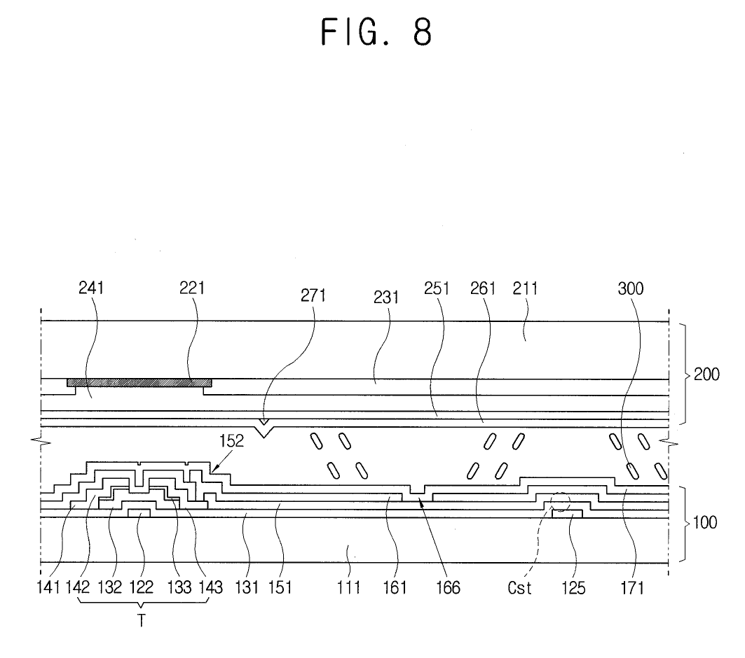

Hereinafter, an LCD device 2 according to a second exemplary embodiment of the present invention will be described with reference to FIG. 8.

A cutting pattern is not formed on a common electrode 251. Instead, a protrusion 271 made of an organic material is formed between the common electrode 251 and a second alignment film 271. The protrusion 271 is provided to divide a liquid crystal layer 300 into a plurality of domains the same as the common electrode cutting pattern 252 in the first exemplary embodiment.

As described above, the present invention provides an LCD device which includes an alignment film of silicon oxide and with a uniform thickness.

Also, the present invention provides a manufacturing method of an LCD device which includes an alignment film of silicon oxide and with a uniform thickness.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display device comprising:
a first substrate which comprises a first insulating substrate and a first alignment film formed on the first insulating substrate;
a second substrate which faces the first substrate and comprises a second insulating substrate and a second alignment film formed on the second insulating substrate; and
a liquid crystal layer disposed between the first alignment film and the second alignment film, at least one of the first alignment film and the second alignment film comprising a silicon oxide layer of which the dielectric constant is 5 to 14.

2. The liquid crystal display device according to claim 1, wherein the liquid crystal layer is a vertically aligned mode.

3. The liquid crystal display device according to claim 1, wherein the silicon oxide layer has a thickness of 200 Å to 3000 Å.

4. The liquid crystal display device according to claim 1, wherein the silicon oxide layer has a surface roughness of 5 Å to 30 Å.

5. The liquid crystal display device according to claim 1, wherein the first substrate further comprises
a pixel electrode which is formed between the first insulating substrate and the first alignment film and has a pixel electrode cutting pattern formed thereon, and
the second substrate comprises a common electrode between the second insulating substrate and the second alignment film having a cutting pattern formed thereon.

6. The liquid crystal display device according to claim 1, wherein the silicon oxide layer is formed by a plasma enhanced chemical vapor deposition method.

7. A manufacturing method of a liquid crystal display device comprising:
forming by vapor deposition an alignment film of silicon oxide (SiOx) on a substrate using a silicon source gas and an oxygen source gas at a temperature of 30° C. to 150° C. while forming plasma in the deposition space.

8. The manufacturing method according to claim 7, wherein the oxygen source gas comprises nitrous oxide (N₂O).

9. The manufacturing method according to claim 7, wherein the silicon source gas comprises monosilane (SiH₄).

10. The manufacturing method according to claim 7, wherein the flux ratio of the oxygen source gas over the silicon source gas is between 150 and 300.

11. The manufacturing method according to claim 10, wherein the oxygen source gas comprises nitrous oxide (N₂O) and the silicon source gas comprises monosilane (SiH₄).

12. The manufacturing method according to claim 7, wherein the alignment film is formed to have a thickness of 200 Å to 3000 Å.

13. The manufacturing method according to claim 7, wherein the alignment film is formed to have a dielectric constant of 5 to 14.

14. The manufacturing method according to claim 7, further comprising applying an electron beam to the alignment film to have a pre-tilt angle.

15. The manufacturing method according to claim 7, wherein the substrate is in a horizontal position in the forming the alignment film.

16. The manufacturing method according to claim 7, wherein a pressure in the deposition space is 10⁻³ torr to 10 torr, power density of plasma is 145 W/cm³ to 580 W/cm³, and the alignment film is deposited at a rate of 4 Å/sec to 16 Å/sec.

17. The manufacturing method according to claim 7, wherein a thin film transistor is formed on an insulating substrate; and a pixel electrode which is electrically connected to the thin film transistor has a cutting pattern formed thereon.

18. The manufacturing method according to claim 7, wherein a common electrode which has a cutting pattern is formed on an insulating substrate.

19. A manufacturing method of a liquid crystal display device comprising:
forming by chemical vapor deposition an alignment film made of silicon oxide (SiOx) on a substrate using a silicon source gas and an oxygen source gas at a temperature of 30° C. to 150° C. while forming plasma in the deposition space.

20. The manufacturing method according to claim 19, wherein the substrate is in a horizontal position in the forming the alignment film.

21. The manufacturing method according to claim 19, wherein a flux ratio of the oxygen source gas over the silicon source gas is between 150 and 300.

22. The manufacturing method according to claim 21, wherein the oxygen source gas comprises nitrous oxide (N₂O) and the silicon source gas comprises monosilane (SiH₄).

23. The manufacturing method according to claim 19, wherein the alignment film is formed to have a thickness of 200 Å to 3000 Å.

24. The manufacturing method according to claim 19, wherein the alignment film is formed to have a dielectric constant of 5 to 14.
